(19) United States
(12) Patent Application Publication
(10) Pub. No.: US 2021/0370640 A1
(43) Pub. Date: Dec. 2, 2021

(54) ANIMAL TOY OR BLANKET

(71) Applicant: DUPONT SAFETY & CONSTRUCTION, INC., Wilmington, DE (US)

(72) Inventors: Yves Bader, Crozet (FR); Kevin Gindi, Brooklyn, NY (US)

(21) Appl. No.: 17/329,483

(22) Filed: May 25, 2021

Related U.S. Application Data
(60) Provisional application No. 63/033,498, filed on Jun. 2, 2020.

(51) Int. Cl. B32B 7/022; A01K 15/02; A01K 1/035; B32B 5/24; B32B 5/02; B32B 7/09; B32B 7/12; D03D 15/573; D03D 15/208; D03D 7/00

(52) U.S. Cl. CPC B32B 7/022; D10B 2331/04; A01K 1/0353; B32B 5/245; B32B 5/024; B32B 5/026; B32B 7/09; B32B 7/12; D03D 15/573; D03D 15/208; D03D 7/00; B32B 2307/54; B32B 2307/5825; D10B 2201/00; A01K 15/026

(57) ABSTRACT

An article comprises core of filler material, and a quilted textile enclosing the core wherein the textile comprises a first fabric having a cover factor between 70% and 95% and a tensile strength of at least 600 N/5 cm, the first fabric being a woven or knit fabric that is in contact with the core material, a second fabric bonded to the first fabric by an adhesive, the second fabric being a plush fabric, located on the side of the first fabric remote from the core, a first quilting yarn on the outer surface of the textile having a tenacity of at least 45 cN/tex and an elongation at break no greater than 10%, a second quilting yarn on the inner surface of the textile having a tenacity of at least 15 cN/tex and an elongation at break greater than 10%.

### BACKGROUND OF THE INVENTION

### Field of the Invention

This invention pertains to an animal toy or blanket.

### Description of Related Art

U.S. Pat. No. 7,870,839 to Sacra describes a flexible, durable pet toy that includes an outer plush layer and an inner fleece layer positioned adjacent thereto and optionally adhesively secured thereto. The outer and inner layers form a shell of a three-dimensional object, and a filling material fills the shell. Seams that join edges of the outer and inner layers are folded inward and are contained within the object. The seams are reinforced with a webbing strip and fastened by thread to create a flexible interior skeleton frame. A method for making such a pet toy is also disclosed.

United States patent publication 2005/0053756 to Axelrod teaches a fabric, fiber or film-based animal toy is provided having improved rupture and tear resistance. The animal toy includes a body including a compressible material and a fabric or film material disposed over at least a portion of the compressible material. The fabric material includes high strength fibers having a tensile strength greater than or equal to 50,000 psi and/or a modulus greater than or equal to 500,000 psi. The film material includes films having a tensile strength equal to or greater than 20,000 psi, and modulus value equal to or greater than 500,000 psi. In addition, the fibers and/or film employed is fiber and/or film material of relatively high monoaxial or biaxial polymer chain orientation.

There remains a need for animal toy or blankets having improved resistance to biting, ripping, scratching etc., particularly from dogs.

### BRIEF SUMMARY OF THE INVENTION

This invention pertains to an article comprising a core of filler material, and a quilted textile enclosing the core wherein the textile comprises
a first fabric having a cover factor between 70% and 95% and a tensile strength of at least 600 N/5 cm, the first fabric being a woven or knit fabric that is in contact with the core material,
a second fabric bonded to the first fabric by an adhesive, the second fabric being a plush fabric, located on the side of the first fabric remote from the core,
a first quilting yarn on the outer surface of the textile having a tenacity of at least 45 cN/tex and an elongation at break no greater than 10%,
a second quilting yarn on the inner surface of the textile having a tenacity of at least 15 cN/tex and an elongation at break greater than 10%, and
a seam having a seam strength of at least 600 N.

### BRIEF DESCRIPTION OF THE DRAWINGS

FIG. 1 is a sectional view of the inventive article,

FIG. 2 is a sectional view of the textile component of the article.

### DETAILED DESCRIPTION OF THE INVENTION

### Article

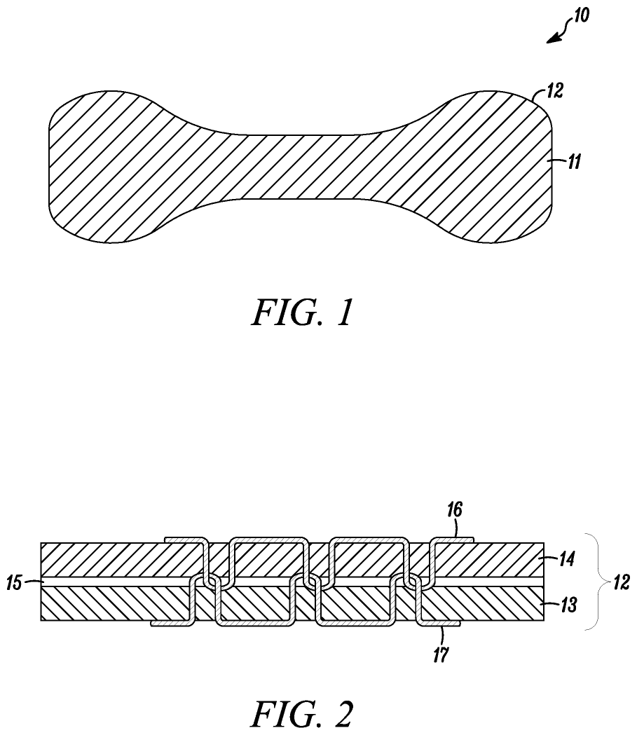

As shown in a sectional view in FIG. 1, the article 10 comprises a core of filler material 11, and a textile 12 enclosing the core. The textile is quilted. The article is not restricted to any particular shape or configuration, exemplary examples being a dog bone, a ring, a ball, a cushion or a blanket.

Preferably, the textile has a tensile strength greater than 1000 N, a tear strength in both the warp and weft of greater than 80 N and a puncture resistance greater than 100 N. Preferably the article is an animal toy such as a dog or cat toy, an animal bed/mattress or an animal blanket.

### Core

The core 11 comprises filler material (stuffing). Such materials preferably have a relatively high bulk density. The filler may be a natural or synthetic batting (fill), such as polyester, nylon, cotton, wool. The stuffing may also be in the form of a foamed polymeric material. The batting may comprise continuous fibers, discontinuous fibers, carded fibers or shredded material. The core may further comprise solid materials or noise producing items.

### Textile

FIG. 2 is a sectional view of one embodiment of a quilted textile 12 that can resist tearing and rupture. The textile comprises first and second fabrics as the two main components.

In one embodiment, the first fabric 13 has a cover factor between 70% and 95% and a tensile strength of at least 600 N/5 cm. In another embodiment the first fabric has a cover factor between 75% and 95%. In yet another embodiment, the first fabric has a cover factor between 80% and 95%.

By cover-factor is meant the fraction of the surface area of the fabric that is covered by yarns i.e. (number of warp yarns/100 mm in warp*sqrt (warp yarn tex)/1000)+(number of weft yarns/100 mm in weft*sqrt(weft yarn tex)/1000)−(number of warp yarns/100 mm in warp*sqrt (warp yarn tex)/1000*number of weft yarns/100 mm in weft*sqrt(weft yarn tex)/1000). Sqrt is square root.

The first fabric 13 may be a woven or knit fabric and is in contact with the core material 11. Preferably, a woven first fabric is a plain, satin or twill weave. A knit fabric may be either a warp or weft knit fabric in styles such as milanese, raschel, tricot, circular or flat. The first fabric is not a fleece.

The first fabric may comprise a single fabric layer or a plurality of sub-component fabric layers.

The second fabric 14 is bonded to the first fabric 13 by an adhesive 15, the second fabric being a plush fabric located on the side of the first fabric remote from the core 11. A plush fabric is a well understood fabric in the textile arts and has a cut nap or pile like fustian or velvet. The second fabric may be a knitted fabric or a woven fabric. The second fabric may also be colored or printed, for example to imitate furs.

The second fabric may comprise a single fabric layer or a plurality of sub-component fabric layers.

Exemplary adhesives include rubber cement, a textile or fabric adhesive or a food grade (food safe) adhesive. In some embodiments, a food grade adhesive is preferred. Preferably, the adhesive is compliant with the European Union requirement Registration, Evaluation, Authorisation and Restriction of Chemicals (REACH).

A further feature is that the textile is quilted. FIG. 2 shows a preferable quilt stitching arrangement through the first and second fabrics 13 and 14 respectively.

A first quilting yarn 16 is located on the outer surface of the textile and has a tenacity of at least 45 cN/tex and an elongation at break of no greater than 10%.

The first quilting yarn may be of p-aramid or p-aramid copolymer available from DuPont, Wilmington, Del. under the tradename KEVLAR. Other suitable yarns are ultra-high molecular weight polyethylene under the trade name SPECTRA from Honeywell International Inc., Charlotte N.C., liquid crystal polymer fiber available as VECTRAN™ from Kuraray America Inc., Houston, Tex. or poly(p-phenylene-2,6-benzobisoxazole) fiber available from Toyobo Co., Ltd., Osaka, Japan under the tradename ZYLON.

A second quilting yarn 17 is located on the inner surface of the textile and has a tenacity of at least 15 cN/tex and an elongation at break greater than 10%.

The second quilting yarn may be the same or different from the first quilting yarn. By different is meant that the yarns are of different chemical composition or, if of the same composition, have different physical properties. The second quilting yarn may be of material such as aromatic or aliphatic polyamide and copolymers thereof, ultra-high molecular weight polyethylene, liquid crystal polymer, poly(p-phenylene-2,6-benzobisoxazole, polyester or cellulose.

In preferred embodiments, the first and second quilting yarns are different.

A preferred stich is a lockstitch (ISO #301) in which the stitch is formed by the thread of the first quilting yarn passing through the second fabric that interlocks at the interface of the first and second fabrics with a thread of the second quilting yarn passing through the first fabric. In a preferred embodiment the quilting pattern is in the form of rows or patterns that are spaced apart by a distance of at least 50 mm.

### Forming the Article

Any suitable method commonly used in the trade may be used to form the article.

Preferably the seam stitching yarn is such that the seam has a seam strength of at least 600 N.

A suitable seam stich is a plain stitch, preferably double stitched.

Exemplary yarn types for the seam yarn are spun yarns or continuous filament yarns of material such as aromatic or aliphatic polyamide and copolymers thereof, ultra-high molecular weight polyethylene, liquid crystal polymer, poly(p-phenylene-2,6-benzobisoxazole, polyester or cellulose.

An adhesive tape can be used in addition to or as an alternative closure means to a stitched seam.

### Test Methods

The tensile strength of the textile was tested according to DIN EN ISO 13934-1, 2013. The tests were carried out on 50 mm×300 mm samples at a speed of 100 mm/min with a 10 kN load cell.

The tear strength of the textile was tested according to DIN EN ISO 13937-2, 2000. The tests were carried out on 50 mm×200 mm samples at a speed of 100 mm/min with a 10 kN load cell.

The seam strength of the textile was tested on 50 mm×300 mm samples as per BS EN ISO 13935-2, 2014.

Puncture resistance was determined as per EN 388, 2016.

### EXAMPLES

The performance of the article to withstand tear, biting etc. is governed by the performance of the textile. Accordingly, textile testing is representative as to how the article will function. The example below describes such a textile assembly and test.

### Example 1

A knitted plush fabric, the second fabric, made of 100% polyester had an areal weight of 200 gsm.

The first fabric was an Oxford weave twill 3/1 fabric having a pick count of 20 yarns/cm in the warp and 11 yarns/cm in the weft. The fabric had a cover factor of 27% and an areal weight of 240 g/m². The yarn of the fabric was 667 dtex (600 denier) polyester.

The two fabrics were assembled with a conventional calendaring process to form the textile 12. A hot melt polyurethane fabric adhesive NEL-1019 from Shanghai AnYu Chemical Company Ltd. was used to aid the bonding of the two layers. This assembly was cut into the pattern necessary to producing the shell of the toy article.

The textile was then quilted. The first quilting yarn 16 had a yarn count of 30/3 and comprised 100% Kevlar® staple yarn of 1.9 dtex (1.7 denier). The second quilting yarn 17 had a yarn count of 40/2 and was a polyester sewing thread. The quilting machine was set at 4 stitches per cm (10 stitches per inch).

The edges of the textile were lock-stitched to form a seam. Two parallel lines of lock stitch were made 3 mm apart to form a double stitched plain seam. An adhesive tape was also used to further bond the first and second fabrics at the edge of the textile. The seam thread on the second fabric was the same Kevlar® staple yarn as used for the first quilting yarn. The seam thread on the first fabric was the same 40/2 polyester sewing thread as used for the second quilting yarn. The seam sewing machine was set at 4 stitches per cm (10 stitches per inch).

Table 1 summarizes the test results.

TABLE 1

| | Test | Test |
|---|---|---|
| Test | Direction | Value (N) |
| Tensile Strength | Warp | 1905 |
| Tear Strength | Warp | 89 |
| Tear Strength | Weft | 106 |
| Seam Strength | Warp | 730 |
| Puncture Resistance | — | 113 |

1. An article comprising a core of filler material, and a quilted textile enclosing the core wherein the textile comprises
a first fabric having a cover factor between 70% and 95% and a tensile strength of at least 600 N/5 cm, the first fabric being a woven or knit fabric that is in contact with the core material,
a second fabric bonded to the first fabric by an adhesive, the second fabric being a plush fabric, located on the side of the first fabric remote from the core,
a first quilting yarn on the outer surface of the textile having a tenacity of at least 45 cN/tex and an elongation at break no greater than 10%,
a second quilting yarn on the inner surface of the textile having a tenacity of at least 15 cN/tex and an elongation at break greater than 10%, and
a seam having a seam strength of at least 600 N.

2. The article of claim 1 wherein the textile has a tensile strength greater than 1000 N, a tear strength greater than 80 N and a puncture resistance greater than 100 N.

3. The article of claim 1 wherein the second quilting yarn is different from the first quilting yarn.

4. The article of claim 1 wherein the first quilting yarn is p-aramid, p-aramid copolymer, ultra-high molecular weight polyethylene, liquid crystal polymer or poly(p-phenylene-2,6-benzobisoxazole).

5. The article of claim 1 wherein the second quilting yarn is p-aramid, p-aramid copolymer, ultra-high molecular weight polyethylene, liquid crystal polymer or poly(p-phenylene-2,6-benzobisoxazole), polyester, aliphatic nylon or cellulose.

6. The article of claim 1 wherein the first fabric is a plain, satin or twill woven fabric.

7. The article of claim 1 wherein the first fabric is a milanese, raschel, tricot, circular or flat knit fabric.

8. The article of claim 1 wherein the second fabric is knitted or woven fabric.

9. The article of claim 1 wherein the quilting pattern is in the form of rows spaced apart by a distance of at least 50 mm.

10. The article of claim 1 wherein the first fabric has a cover factor between 75% and 95%.

11. The article of claim 1 wherein the seam has a strength of at least 800 N.

12. The article of claim 1 wherein the seam is a plain seam.

13. The article of claim 1 wherein the core material is a natural or synthetic batting or a foamed polymeric material.

14. The article of claim 1 wherein the article is an animal toy, an animal bed/mattress or an animal blanket.

15. The article of claim 1 wherein the adhesive is a rubber cement or food grade adhesive.

16. The article of claim 10 wherein the first fabric has a cover factor between 80% and 95%.

17. The article of claim 13 wherein the batting is polyester, nylon, cotton or wool.
